(19) United States
(12) Patent Application Publication
(10) Pub. No.: US 2025/0323546 A1
(43) Pub. Date: Oct. 16, 2025

(54) CONTINUOUS STATOR WINDING WITH LARGE AND SMALL WIRES

(71) Applicant: BorgWarner Inc., Auburn Hills, MI (US)

(72) Inventors: David A. Fulton, Anderson, IN (US); Kirk Neet, Noblesville, IN (US)

(21) Appl. No.: 19/177,117

(22) Filed: Apr. 11, 2025

Related U.S. Application Data
(60) Provisional application No. 63/632,988, filed on Apr. 11, 2024.
(60) Provisional application No. 63/638,740, filed on Apr. 25, 2024.

(51) Int. Cl. H02K 3/28

(52) U.S. Cl. CPC H02K 3/28

(57) ABSTRACT

A stator includes a stator core with a plurality of slots and a winding arrangement formed from a plurality of parallel paths. Each parallel path includes a first continuous wire connected in series with a second continuous wire and a third continuous wire, wherein the second and third continuous wire are in parallel. The first continuous wire has a first cross-sectional area and forms a plurality of layers in the back of each slot near the outer diameter. The second and third continuous wire each have a second cross-sectional area and are used to form a plurality of layers in the front of each slot near the inner diameter of the stator. The first cross-sectional area is greater than the second cross-sectional area.

### CROSS-REFERENCE TO RELATED APPLICATIONS

This application claims priority from U.S. provisional patent application No. 63/632,988, filed Apr. 11, 2024, and U.S. provisional patent application No. 63/638,740, filed Apr. 25, 2024, the disclosures of which are incorporated herein by reference in their entirety.

### FIELD

This application relates to the field of electric motors and particularly to winding arrangements for stators.

### BACKGROUND

Many modern electric motors are designed to operate within a wide range of speeds. These motors may experience significant AC loss during operation. When the AC losses are significant, the AC losses may result in an inefficient electric machine.

Stators are typically wound with copper wire in the slots. Large copper wire is typically desirable in order to limit DC resistance. Small copper wire is typically desirable in order to limit AC resistance due to skin effect and proximity losses. The AC losses are typically even higher near the ID of the slots.

In view of the foregoing, it would be advantageous to provide a winding arrangement for a stator that is configured to limit AC losses. It would be of further advantage if the winding arrangement could be formed on the stator core with relative ease and without a substantial increase in manufacturing costs.

### SUMMARY

An improved stator is disclosed herein including a stator core with a plurality of slots and a winding arrangement positioned on the stator core. The stator core defines an inner diameter (ID) and an outer diameter (OD). The winding arrangement includes a plurality of parallel paths. Each parallel path includes a first continuous wire connected to a second continuous wire. The first continuous wire has a first cross-sectional area and forms a plurality of layers in the back of each slot near the OD. The second continuous wire has a second cross-sectional area and forms a plurality of layers in the front of each slot near the ID of the stator. The first cross-sectional area is at least 50% greater than the second cross-sectional area.

In at least one embodiment, a stator includes a stator core with a plurality of slots and a winding arrangement formed from a plurality of parallel paths. Each parallel path includes a first continuous wire connected in series with a second continuous wire and a third continuous wire, wherein the second and third continuous wire are in parallel. The first continuous wire has a first cross-sectional area and forms a plurality of layers in the back of each slot near the OD. The second and third continuous wire each have a second cross-sectional area and are used to form a plurality of layers in the front of each slot near the ID of the stator. The first cross-sectional area is greater than the second cross-sectional area.

In at least one embodiment, a stator for an electric machine comprises a stator core including a plurality of teeth with slots formed between the teeth, the stator core defining an ID and OD, each slot of the stator core including a back portion closer to the OD and a front portion closer to the ID. The stator further includes a winding arrangement positioned on the stator core, the winding arrangement including a plurality of conductors forming a plurality of parallel paths, each parallel path including an outer portion arranged in the back portion of each slot and an inner portion arranged in the front portion of each slot. The outer portion is provided by primary continuous conductor and a secondary continuous conductor, the primary continuous conductor and the secondary continuous conductor having a first cross-sectional area and arranged in at least two layers in the back portion of each slot. The inner portion is provided by at least two second continuous conductors having a second cross-sectional area and arranged in at least one of two layers in the front portion of each slot, the first cross-sectional area greater than the second cross-sectional area, wherein the at least two second continuous conductors are connected in parallel, and wherein a finish lead of the secondary continuous conductor is connected in series with start leads of the at least two second continuous conductors, and wherein a start lead of the primary continuous conductor is connected in series with finish leads of the at least two second continuous conductors.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a tabular view of one phase of a winding arrangement for a stator including a continuous winding with large and small wires/conductors and the locations of weaves between conductor in specific slots of the winding arrangement;

FIG. 2 shows another tabular view of the winding arrangement of FIG. 1 further illustrating welds between large and small conductors in specific slots of the winding arrangement;

FIG. 3 shows another tabular view of the winding arrangement of FIG. 1 further illustrating the position of end-turns above the slots of the winding arrangement;

FIG. 4 shows a perspective view of an exemplary stator core configured to receive the winding arrangement of FIG. 1;

FIG. 5 shows a cross-sectional view of an arrangement of the large and small conductors of the winding arrangement of FIG. 1 in four slots of a stator core; and

FIG. 6 shows a side view of conductors for the winding arrangement of FIG. 1 illustrating a method of forming the conductors for the winding arrangement.

### DESCRIPTION

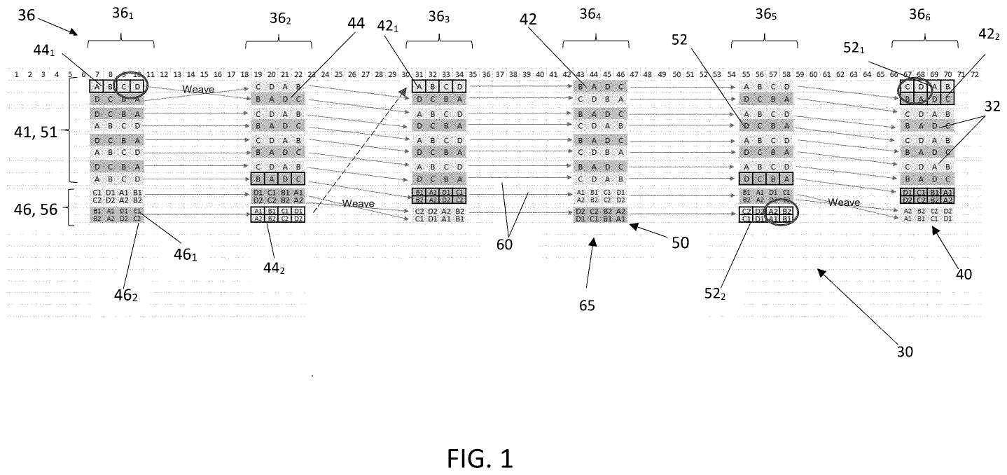

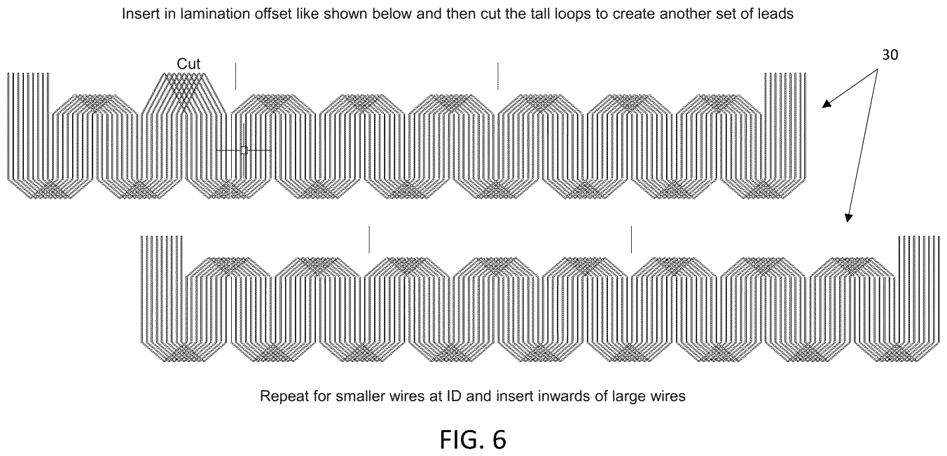

As shown in FIGS. 1-6 herein, a stator includes a stator core 12 with a winding 30 formed thereon. The winding 30 includes a plurality of conductors connected together to form a winding with multiple parallel paths and multiple phases. Each parallel path includes a first continuous conductor 40 defined by a larger cross-section and at least two second continuous conductors 50 defined by a smaller cross-section. The first continuous conductor 40 is arranged in layers near the outer diameter (OD) of the core and the second continuous conductor 50 is arranged in layers near the inner diameter (ID) of the core.

The following description of embodiments of the stator for an electric machine makes use of relative terms that are dependent on an orientation of the electric machine at a given time (e.g., during manufacture or use of the machine in a vehicle). Accordingly, it will be recognized that many terms of orientation and position as used herein are defined with reference to what may be shown in the drawing and/or other common positions. While efforts have been made herein to reference portions of the electric machine with respect to non-changing features (e.g., “axial,” “radial” and “circumferential” directions and related positions of the stator), it will be recognized that other terms are relative terms that depend on the position of the electric machine. For example, the terms “top” (or “upper”), “bottom” (or lower), “left” or “right” may be used herein in association with what is shown in a drawing, but such positions may switch or change if the electric machine is placed in a different position. As another example, the term “above” references a relative position where one component is vertically higher than another component, and the term “below” references a relative position where one component is vertically lower than another component.

### Stator Core

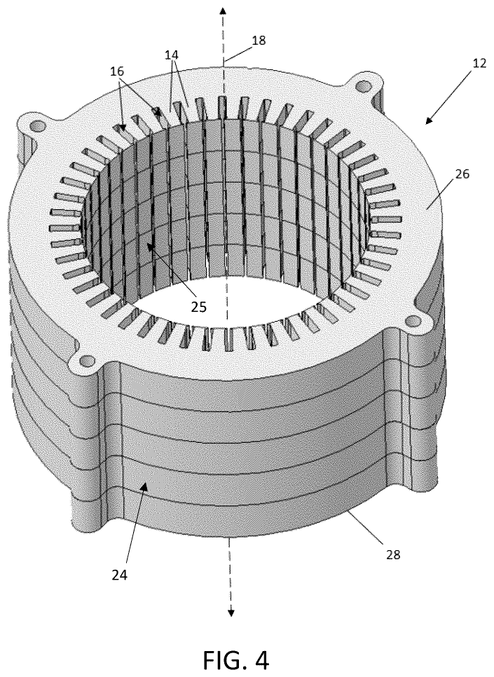

With initial reference to FIG. 4, a view of the stator core 12 is shown in isolation from the winding 30. The stator core 12 is comprised of a ferromagnetic material and is typically formed from a plurality of sheets of magnetic-permeable material (e.g., steel, soft magnetic composite, or other appropriate material) that are stamped and stacked upon one another to form a lamination stack. The stator core 12 is generally cylindrical in shape as defined by a center axis 18, and includes an outer perimeter surface 24 and an inner perimeter surface 25. The outer perimeter surface 24 defines the outer diameter (OD) for the stator. The inner perimeter surface 25 defines the outer diameter (ID) for the stator.

A plurality of teeth 14 are formed on the interior of the stator core 12 and directed inwardly toward the center axis 18. Each tooth 14 extends radially inward from a back iron 21 and terminates at the inner perimeter surface 25. Axial slots 16 are formed in the stator core 12 between the teeth 14. Each slot 16 is defined between two adjacent teeth, such that two adjacent teeth form two opposing radial walls for one slot. The teeth 14 and slots 16 all extend from a first end 26 to a second end 28 of the core.

The slots 16 may be open or semi-closed along the inner perimeter surface of the stator core 12. When the slots 16 are semi-closed, each slot 16 has a width that is smaller at the inner perimeter surface than at more radially outward positions (i.e., slot positions closer to the outer perimeter surface). When the slots are open, conductors may be inserted into the slots from the ID. In addition to the radial openings to the slots 16 through the inner perimeter surface (i.e., for open and semi-closed slots), axial openings to the slots 16 are also provided the opposite ends 26, 28 of the stator core 12.

The stator core 12 is configured to retain the winding 30 (which may also be referred to as a “winding arrangement”) within the slots 16 of the stator core 12. The winding arrangement 30 is formed from a plurality of conductors that are retained within the slots 16. The conductors are formed of copper or other electrically conductive material that form in-slot portions and end-loops (which may also be referred to as “end-turns”) that extend between the in-slot portions and wrap around the teeth of the core.

### First Embodiment of Winding Arrangement

With particular reference now to FIGS. 1-3, a tabular view of one phase of the winding arrangement 30 is shown. The winding arrangement 30 includes a plurality of conductors 32 forming a multi-phase winding on the stator core 12. The multi-phase winding includes a plurality of parallel paths arranged in the slots of the core. Each of the plurality of parallel paths include a first half-path portion 40 of the path as illustrated by orange conductors in FIGS. 1-3, and a second half-path portion 50 of the path as illustrated by blue conductors in FIGS. 1-3. However, it will be noted that in other embodiments, each parallel path may be formed by two first half-path portions 40 or two second half-path portions 50 connected in series, as described in further detail below. It will be recognized that the “orange” and “blue” designations are merely for convenience in easily illustrating and distinguishing the different sets of parallel paths in the winding disclosed herein. A related winding arrangement to that shown in FIGS. 1-3 is described in U.S. patent application Ser. No. 19/176,948, filed Apr. 11, 2025, the entire contents of which are incorporated by reference herein. In the embodiment of FIGS. 1-3, the winding is defined by four slots-per-pole-per-phase, but it will be recognized that a different number of slots-per-pole-per phase may be utilized in other embodiments.

The winding 30 disclosed herein may be considered to be a “substantially weaveless” winding arrangement. A “weaveless” winding arrangement is one that is void of any weaves between any of the parallel paths of the winding. A “substantially weaveless” winding arrangement is a winding that has only one or two weaves per phase (e.g., in order move leads to an outermost or inner most layer of the winding arrangement). A “weave” occurs in a winding when end turns of adjacent conductors cross one another in order to exchange slot order or layer order for the conductors between adjacent slot sets. Thus, a weave occurs when adjacent conductors in two successive layers of one slot set exchange layer positions (i.e., inward/outward) in the adjacent slot set. For example, a weave occurs when two left-right conductors in layer #1 of a first slot set move to layer #2 in the second slot set, and the left-right conductors in layer #2 of the first slot set move to layer #1 in the second slot set. This results in the need to weave the conductors such that the end turns cross one another between the slot sets. A “weave” will be distinguished from an “over-under” end turn arrangement wherein the left-right paths for one phase never cross one another when switching from left to right and vice-versa. Instead, when moving from one slot set to the next, over-under end turns 60 allow the two conductors to simply exchange positions between slot sets.

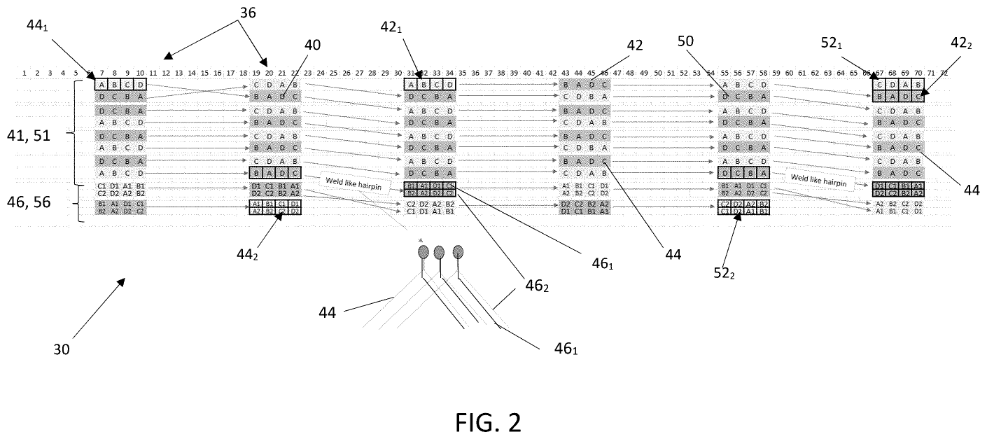

One exemplary embodiment of a stator with an S-winding is disclosed in U.S. Pat. No. 11,545,867, the entire contents of which is incorporated herein by reference. However, this S-winding results in leads on opposite sides of the stator core and requires the use of a busbar to connect leads on opposite sides of the stator core. In order to accomplish an S-wind with a weaveless design (or substantially weaveless design) as disclosed herein, over-under end turns are utilized. Additionally, each first half-path 40 (e.g., orange path portions in FIGS. 1-3) is formed by four continuous lengths of wire and each second half-path 50 (e.g., the blue path portions in FIGS. 1 and 2) is formed by three continuous length of wire, as described in further detail below. A length of “continuous” wire is a length of wire that does not include a coupling (e.g., a weld, bond or other mechanical connection) other than the wire itself. Additionally, the term “half-path” as used herein references a portion of path that is extends at least from one of the two outermost layers to one of the two innermost layers of the winding arrangement, and is not limited to a length of conductor that is exactly half the length of the path.

It will be recognized that the winding illustrated in FIGS. 1-3 includes a plurality of parallel paths (i.e., paths A-D) wherein each parallel path includes a first half-path 40 (shown in orange in FIG. 1) and a second half-path 50 (shown in blue in FIG. 1). The first half-paths 40 may also be referred to herein as the “orange path portions” and the second half-paths 50 may also be referred to herein as the “blue path portions.” The set of orange path portions 40 includes four path portions identified as paths A1, B1, C1 and D1. The set of blue path portions includes four path portions identified as paths A2, B2, C2 and D2. The winding arrangement 30 in the embodiment of FIGS. 1-3 includes six poles with four slots-per-pole-per phase, and ten layers in each slot.

The slot graphs of FIGS. 1-3 illustrate the slots 16 associated with each pole/slot set 36 of the winding arrangement (i.e., slot sets 36₁-36₆) and the positions of the conductors in each slot. The slots 16 associated with a pole are also referred to herein as a “slot set” 36 for the associated pole and phase of the electric machine. For the sake of simplicity, FIGS. 1-3 only shows the slot sets for a single phase of the winding arrangement.

The slot graphs of FIGS. 1-3 shows the particular path portion (i.e., A1-D1 of the orange path portions 40 or A2-D2 of the blue path portions 50) associated with each layer of each slot. As can be seen in FIGS. 1-3, this embodiment of the winding arrangement includes twelve layers of conductors in each slot with half of the layers filled with conductors from the orange path portions 40 and half of the layers filled with conductors from the blue path portions 50. The arrows extending between the slot sets represent sets of end loops 60 extending between the slot sets. It will be recognized that each of slot sets 36₁-36₆ includes two adjacent slot sets (i.e., a left slot set and a right slot set on either side of a given slot set). While the stator core 12 is shown as linear in FIGS. 1-3 for the sake of convenience, it will be appreciated that the stator core 12 is actually annular, and therefore slots sets 36₁ and 36₆ are also adjacent slot sets. Although arrows are not shown in FIGS. 1-3 extending from slots set 36₆ to 36₁, it will be recognized that end turns 60 also connect conductors in the same layers of these adjacent slot sets.

With continued reference to FIGS. 1-3, each first half-path 40 (e.g., the orange path portions) includes an outer portion 41 arranged in the back portion of the slots and an inner portion 46 arranged in the front portion of the slots. The outer portion 41 is provided by a primary length of continuous wire 42 and a secondary length of continuous wire 44 that are connected at their ends to form the outer portion 41 in the back portion of the slots (i.e., in layer #s 1-8 in the embodiment of FIGS. 1-3). The primary length of continuous wire 42 for each orange path portion is relatively short in comparison to the secondary length of continuous wire 44.

The primary length of continuous wire 42 for the outer portion 41 of each orange path portion begins in the outermost layer of the slots (i.e., layer #1) on a first half of the stator core as shown as shown by primary start leads 42₁ in FIGS. 1-3 (the half of the stator core associated with slot sets 36₂, 36₃ and 36₄ in FIGS. 1-3 may be referred to herein as “Side A” of the stator core). From there, the primary length of continuous wire 42 wraps partially around the stator core—to an opposite/second half of the stator core—and terminates in the second layer of the slots (i.e., layer #2) as shown by primary finish leads 422 in FIGS. 1-3. Accordingly, the primary length of continuous wire 42 does not even make one complete wrap around the stator core 12 and particularly makes approximately ½ of a wrap around the stator core.

The secondary length of continuous wire 44 for the outer portion 41 of each orange path portion begins in the first layer of the slots on the opposite/second half of the stator core as shown by secondary start leads 44₁ in FIGS. 1-3 (the half of the stator core associated with slot sets 36₅, 36₆ and 36₁ in FIGS. 1-3 may be referred to herein as “Side B” of the stator core, which is 180° opposite Side A). From there, the secondary length of continuous wire 44 wraps around the stator core multiple times until the orange path portion splits into two parallel paths following layer #8 of slot set 36₂.

The inner portion 46 of each orange path is provided by at least two second continuous conductors that are connected in parallel to the outer portion 41. The inner portion 46 is arranged in the front portion of the slots (i.e., in layer #s 9-12 in the embodiment disclosed herein). The two second continuous conductors for the inner portion 46 of each orange path portion are illustrated in FIGS. 1-3 by paths A1-A2, B1-B2, C1-C2, and D1-D2, each of which are respectively connected in parallel (i.e., A1 in parallel with A2, B1 in parallel with B2, etc.). Together, the outer portion 41 and the inner portion 46 form one complete first half-path 40.

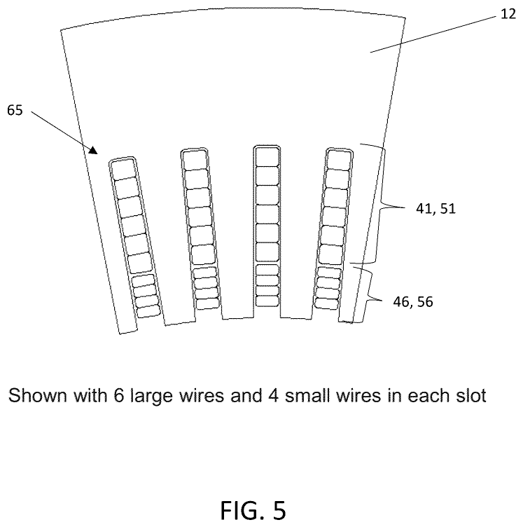

With continued reference to FIGS. 1-3, the two second continuous conductors 46₁ and 46₂ that form the inner portion 46 of each orange path portion are provided by wires having a substantially smaller cross-section that the cross-section of the wires use in the outer portion 41. For example, the cross-sectional area defined by the conductors of the outer portion 41 is at least 50% greater than the cross-sectional area defined by the conductors of the inner portion 46. In the embodiment disclosed in the figures, the cross-sectional area defined by the conductors (A-D) of the outer portion 41 is about twice cross-sectional area defined by the conductors (A1-D1 and A2-D2) of the inner portion 46 (e.g., A_{cross-section}=2×A1_{cross-section}, +/−10%). Accordingly, layers 9 and 10 consume about the same amount of space in a slot as one of layer #s 1-8. Additionally, layers 11 and 12 also consume about the same amount of space in a slot as one of layer #s 1-8. As shown in FIGS. 1-3, the smaller conductors (A1-D1 and A2-D2) of the inner portion 46 are inserted radially inwards of the larger wires of the outer portion 41 and shifted forward by one pole. FIG. 5 shows an example cross-sectional view of a stator with conductors in the slots including larger wires on an outer portion and smaller wires on an inner portion. However, it will be recognized that the embodiment of FIG. 5 is slightly different than that shown in FIGS. 1-3 because only ten layers of conductors are shown in each slot in the embodiment of FIG. 5 instead of twelve layers in each slot as shown in the embodiment of FIGS. 1-3.

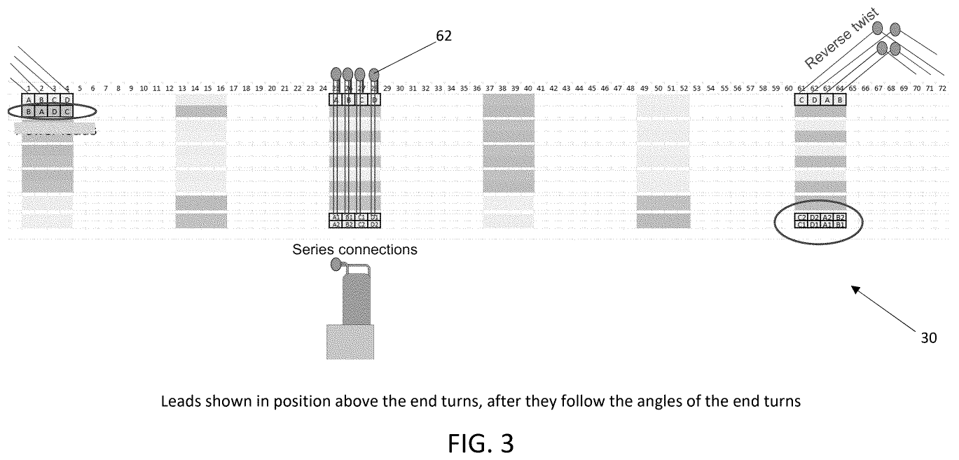

In order to connect the smaller conductors (A1-D1 and A2-D2) of the inner portion 46 to the larger conductors (A-D) of the outer portion, the end leads of the secondary length of continuous wire 44 are connected to the start leads of the smaller conductors. This connection is provided by a coupling, such as a weld coupling 62 (see FIG. 3), that joins the leads near the OD of the stator core. Each weld coupling joins one large wire from the outer portion 41 to two small wires from the inner portion 46. The leads follow the same angle as the end loop angle so that they emerge from the top of the end loops basically in the same circumferential position. This creates an easy weld pattern.

The two smaller wires of the inner portion 46 look the same and are stacked in the radial direction. In the embodiment disclosed herein, each pair of parallel wires within a path (e.g., A1, A2) include at least one weave. For example, as shown in FIGS. 1-3, a weave in the orange paths occurs between layer #s 9-10 (slot set 36₅) and layer #s 11-12 (slot set 36₆). The reason for the weave with the smaller cross-section conductors is to switch spots for the two parallel wires in a path within in the slots. This weave advantageously allows the two smaller wires in each path to be electrically balanced. Electrically balanced parallel wires reduce recirculating currents and increase motor efficiency. Balanced wires have the same or similar average layer position in all the slots. The weave swaps the radial layers of the two parallel wires so that they have the same or similar layer average for the whole winding.

It will be noted that the large wires in the outer portion 41 of each orange path may be inserted with half the leads on Side A and half the leads on side B in order to reduce the total amount of weaves in the winding arrangement 30. As shown in FIG. 1, the weave shown in between slot sets 36₁ and 36₂ (i.e., the large wires of the outer portion 41) on the OD of the stator assists, not with balancing, but to put the orange leads A, B, C, D in slots #s 7, 8, 9, 10 on the outside layer of the winding. These leads are arranged on the outer layer so that the blue leads in the outside layer C, D, A, B in slot #s 67-70 can be reverse twisted and easily connected (e.g., welded) to the leads A, B, C, D in slot #s 7-10.

With continued reference to FIGS. 1-3, it will be noted that the two smaller parallel wires of each path of the inner portion 46 terminate in end leads 44₂ at slot set 363. In order to complete each orange half-path 40, a series connection is made between the end leads 44₂ of each smaller parallel wires and the start lead 42₁ of the associated larger primary length of continuous wire 42 (e.g., the leads 44₂ of A1 and A2 are connected to lead 42₁ of A). This series connection at Side A is shown in FIG. 3 by weld couplings 62 that connect two smaller wires to one larger wire for each path. For example, as shown in FIG. 3, smaller wires A1 and A2 are bent over the end loops to a position radially outward from slot #25 (as shown in FIG. 3) and welded to larger wire A at this position. The leads in FIG. 3 are shown after they twist and follow the angle of the common end loops for six slots. The large leads A, B, C, D twist to the left and the smaller leads A1, A2, B1, B2, C1, C2, D1, D2 twist to the right. A connection between the large leads A, B, C, D and the smaller leads A1, A2, B1, B2, C1, C2, D1, D2 is made radially outward from slot #s 25-29. With these connections made between the outer portion 41 and the inner portion 46 of each orange half-path 40, the orange half-paths are complete. The finish leads 42₁ of the primary length of continuous wire 42 and the start leads 44₁ of the secondary length of continuous wire 44 serve as the leads to each first half-path 40 (either neutral or power leads). Accordingly, it will be noted that each first half-path 40 is formed by four different lengths of continuous wire (including series connected lengths 42 and 44 and parallel connected lengths 46₁ and 46₂) that are connected together to form the half-path (the orange path portion).

With continued reference to FIGS. 1-3, it will be noted that the second plurality of half-paths 50 are differently configured than the first plurality of half-paths 40. In contrast to the first plurality of half-paths 40 (orange path portions), the outer portion 51 each of the second plurality of half-paths 50 (blue path portions) is formed by only a single length continuous wire instead of primary and secondary lengths of conductors 42 and 44. The length of continuous wire for each outer portion of the blue path begins in the outermost layer of the slots (i.e., layer #1) on one half of the stator core as shown by start leads 52₁ in FIGS. 1 and 2. From there, the outer length of continuous wire 51 wraps around the stator core multiple times and terminates in one of the inward layers (i.e., layer #8) of the slots (i.e., at slot set 36₅). At this point, the primary length of continuous wire 51 for the blue path connects to two of the parallel inner portions 56 of the blue path. The two parallel inner portions 56 of the blue path then terminate at the finish leads 52₂ as shown in FIGS. 1 and 2.

While the outer portions 51 of the blue path portions 50 are different than the outer portions 41 of the orange path portion, the inner portions 56 of the blue path portions 50 are the same as the inner portions 46 of the orange path portions. Specifically, similar each inner portion 56 of a blue path portions 50 includes two second continuous conductors that are connected in series. The inner portions 56 of each blue path portion 50 are illustrated in FIGS. 1-2 by paths A1-A2, B1-B2, C1-C2, and D1-D2, each of which are respectively connected in parallel (i.e., A1 in parallel with A2, B1 in parallel with B2, etc.). Together, the outer portion 51 and the inner portion 56 form one complete second half-path 50. Connections between wires that form the blue path portions 50 will be readily apparent from the drawings and from associations with the foregoing description of the orange path portions 40. Accordingly, details of all connections of the blue path portions 50 are not explained in detail herein.

The disclosed winding design shown in FIGS. 1-3 provides a winding arrangement wherein start leads and finish leads for the plurality of parallel paths of the winding are all positioned on a same half of the stator core. The term “half” of a stator core/winding as used herein refers to a portion of the stator core that spans an arc of 180° (and includes half of the poles). For example, all of the start leads and finish leads for the plurality of parallel paths of the winding 30 are on the same half of the winding because each of leads 44₁ and 52₂ are arranged in half the poles (i.e., in three contiguous poles of the six poles, as indicated by slot sets 36₅, 36₆, and 36₁). Furthermore, it will also be noted that all of the connections between the first half-paths (orange leads 42₂) and the second half-paths (blue leads 52₁) are all positioned in the two backmost layers and the two frontmost layers on this same half of the stator core.

As shown in FIGS. 1-3, each slot set 36 is comprised of four slots with ten layers in each slot and conductors of a single phase of the winding 30 in each slot (including five conductors from the orange path portions and five conductors from the blue path portions). Also, each layer of the slot set only includes conductors from either the orange path portions or the blue path portions, but not both. For example, layer #1 of slot set 36₂ only includes conductors from the blue parallel paths (i.e., conductors A₂-D₂), and layer #2 of the slot set 36₂ only includes conductors from the orange parallel paths (i.e., conductors A₁-D₁).

With continued reference to FIGS. 1-3, it will be recognized that each set of parallel paths for the winding arrangement 30 includes pairs of “adjacent parallel paths” that are always located in the same layer of adjacent slots (which may also be referred to herein as simply “adjacent paths”). For example, parallel paths A and B are adjacent paths (i.e., “adjacent parallel paths A1-B1,”) because each instance of an “A” in a layer of a slot 16 includes an instance of “B” in the same layer of an adjacent slot. This is true for both the orange path portions (i.e., A1-B1) and the blue path portions (i.e., A2-B2) of the parallel path. Therefore, the orange path portions 40 include two pairs of adjacent paths (i.e., A1-B1 and C1-D1) and the blue path potions 50 also include two pairs of adjacent paths (i.e., A2-B2 and C2-D2).

In addition to adjacent parallel paths being defined by two paths that are always located in the same layers of adjacent slots, adjacent parallel paths also exchange slot positions with each successive slot set. For example, path portions A1 and B1 are always found in the same layer of a given slot set, but the position of path portions A1 and B1 switch left and right positions with each successive slot set (e.g., path portion A1 is in the left position and path portion B1 is in the right position of layer #3 in slot set 36₅, but path portion A1 is in the right position and path portion B1 is in the left position of layer #4 in slot set 36₆). This switching of slot positions for adjacent paths in successive slot sets is accomplished with only the use over-under end turns. In view of these over-under end turns, a position of the first parallel path relative to the second parallel path alternate at successive adjacent poles for an entirety of the first parallel path and the second parallel path. Furthermore, in view of the over-under end turns and the unique configuration of different lengths of continuous wire to form the respective half-paths 40 and 50 for each of the parallel paths of the winding arrangement 30, it will be recognized that the winding arrangements 30 disclosed herein are formed without the need for any weaving of conductors between the parallel paths of the winding arrangement.

It will be recognized that start leads and end leads for each consecutive length of conductor wire are illustrated in FIGS. 1-3 by black boxes that surround conductors in specific layers of specific slot sets. In other words, these black boxes indicate that there is a termination in the continuous conductors for the parallel paths at this slot. The terminations of the continuous conductors provide either phase leads, neutral leads, or in-path coupling points (i.e., series connections within a path) for the conductors. For example, in FIG. 1, the black boxes around the conductors in layer #1 and slot #s 9 and 10 of slot set 36₁ (i.e., the leads circled in red in slot set 36₁) may serve as power leads for parallel paths C and D of the winding. Similarly, the black boxes around the conductors in layer #s 11-12 and slot #s 57 and 58 of slot set 36₅ (i.e., the leads circled in red in slot set 36₅) may serve as power leads for parallel paths A and B of the winding (e.g., for a wye winding or a delta winding). The black boxes around the conductors in layer #s 1 and 2 of slot #s 67 and 68 (i.e., the leads circled in red in slot set 36₆) may serve as neutral leads for each of parallel paths A, B, C and D of the winding. The remaining black boxes in slot sets 36₁, 36₅ and 36₆ are used as leads that connect first half-paths (orange) to second half paths (blue). To connect first half-path A (orange) to second half-path A (blue), the lead A (orange) in layer #1 of slot #7 is connected to the lead A (blue) in layer #1 of slot #69. To connect first half-path B (orange) to second half-path B (blue), the lead B (orange) in layer #1 of slot #8 is connected to the lead B (blue) in layer #1 of slot #70. These series connections could be made by a reverse twist or other appropriate connection method. To connect first half-path C (orange) to second half-path C (blue), the lead C (orange) in layer #2 of slot #70 is connected to the leads C1 and C2 (blue) in layer #s 11 and 12 of slot #55. To connect first half-path D (orange) to half-path D (blue), the lead D (orange) in layer #2 of slot #69 is connected to the leads D1 and D2 (blue) in layer #s 11 and 12 of slot #56. These series connections may be made by a connection wherein the leads extend above the end turns 60, and a physical and electrical connection between the leads is made radially outward and axially outward from the end turns.

In addition to the above, the black boxes around the conductors in layer #s 11 and 12 of slot set 36₂ (i.e., slot #s 19-22) and layer #1 of slot set 36₃ (i.e., slot #s 31-34) are internal path leads that are connected with four respective couplings (e.g., four welds) in order to provide series connections between the primary lengths of continuous wire 42 and parallel inner lengths 46₁ and 46₂ within the orange path portions (e.g., A1-A2 connected to A). With this connection arrangement, it will be recognized that the S-wind includes all leads to the winding arrangement on one half of the stator core. Specifically, the power and neutral leads are all located in consecutive slot sets 36₁, 36₅ and 36₆ in the embodiment of FIGS. 1-3.

As noted previously, FIGS. 1-3 includes a series of arrows to illustrate the end-turn connections 60 between the in-slot portions 65 of each set of parallel paths (i.e., the orange path portions 40 and the blue path portions 50). By following the arrows, it can be seen that the four orange path portions 40 (noted by paths A-D) and the four blue path portions 50 (noted by paths A-D) each make five clockwise revolutions around the core 12 from the outermost layer to the innermost layer of the stator core 12. The term “revolution” as used refers to a wrap of the conductors substantially around and through the slots of the stator core even if the winding does not completely encircle the stator core a full 360° (e.g., a parallel path that wraps 345° around the stator core is considered to makes a revolution of the stator core even though it may not completely encircle the stator core a full 0° for some reason, such the parallel path ending in leads).

An exemplary winding progression for two adjacent parallel paths of the plurality of parallel paths will now be described with reference to adjacent paths C-D. Adjacent paths C-D are one of two adjacent paths of the winding arrangement of FIG. 1, the other adjacent paths being paths A-B. The power leads/start leads for the adjacent paths C-D in FIGS. 1-3 are the leads identified by reference numeral 44₁ in layer #1 of slot #s 9 and 10. The neutral/finish leads for adjacent paths C-D are the leads identified by reference numeral 52₁ in layer #1 of slot #s 67 and 68.

Progression for the adjacent path C-D is described starting at leads 44₁ of the orange path portion 40 of FIG. 1. After entering the stator core at layer #1 of slot #s 9 and 10 (i.e., the power leads), the conductors for adjacent paths C-D move radially inward and progress to successive slot set 36₂. As discussed previously herein, the end turns of the winding 30 are over-under end turns that flip the position of paths C and D between the two slot sets 36₁ and 36₂ (i.e., path C moves from a left position in slot set 36₁ to a right position in slot set 36₂ and path D moves from a right position in slot set 36₁ to a left position in slot set 36₂). Adjacent paths C-D then continue in a wave-like manner, flipping in successive slot sets and periodically moving inwardly one layer until reaching layer #8 of slot set 36₂. The outer portion 41 of each path ends at layer #8 and the path transitions to the inner portion 46 of the path.

At layer #8, each of adjacent paths C-D is split into two wires. Specifically, path C is split into wires C1 and C2 in layers 9 and 10, and path D is split into wires D1 and D2. These conductors (C1, C2, D1, D2) then continue to progress through the slots. As discussed previously, in order to balance the windings, a weave is included between slot sets 36₅ and 36₆.

At layer #s 11 and 12 of slot set 36₂, a connection is made between the internal leads of the orange path portions 40. These internal leads are identified in FIG. 1 as leads 44₂ and 42₁. Specifically, the leads 44₂ are associated with the internal conductors in layer #s 11 and 12 of slot set 36₂ (i.e., slot #s 21-22) and the leads 44₁ are associated with the outer conductors in layer #1 of slot set 363 (i.e., slot #s 33-34). The connection between the internal leads is illustrated in FIG. 1 by a red dotted line that extends between layer #s 11 and 12 of slot set 36₂ and layer #1 of slot set 363. These leads 44₂ and 42₁ are connected for path C-D with two respective couplings (e.g., two welds). These couplings provide series connections for adjacent paths C-D. As discussed previously herein, this series connection is a unique connection that spans over the top of the other end turns 60 between slot sets 36₂ and 36₃ and connects the internal parallel conductors for the path in layer #s 11 and 12 (near the ID) to the outer conductors in layer #1 (near the OD).

With continued reference to FIGS. 1-3, after reaching slot set 36₃, the adjacent paths C-D continue to wind through the stator core with the primary length of continuous wire 42. This primary length of continuous wire 42 is relatively short compared to the other lengths of wire in the path, and only completes approximately ½ a revolution around the stator core until terminating at leads 42₂ in layer #2 of slot set 36₆. This completes the progression of the first half-paths (orange) of adjacent parallel paths C-D through the stator core.

At slot set 36₆, the first half-paths (orange) of adjacent parallel paths C-D are connected in series to the second half-paths (blue) of adjacent parallel paths C-D. As noted previously, these connections between the respective half-paths are provided between slot set 36₆ (layer #2) and slot set 36₅ (layer #s 11 and 12).

Second adjacent half-paths C-D (blue path portions) also traverse a similar winding path around the stator core as that described above for the first adjacent half-paths C-D (orange path portions). Specifically, adjacent half-paths C-D (blue) start in layer #1 of slot set 36₆ (i.e., the neutral leads C and D which extend from slot #s 67 and 68 of the stator core) and end in layer #s 11 and 12 of slot set 36₅ where the blue half-path C is connected to the orange half-path C and the blue half-path D is connected to the orange half-path D.

The above-described progression is illustrative of one set of adjacent parallel paths of the winding 30. Adjacent paths A-B traverse a similar winding path around the stator core.

### Other Embodiments of the Winding Arrangement

While two exemplary embodiments of the winding arrangement 30 have been described above, it will be recognized that numerous other winding arrangements are possible. For example, different connections may be made between the leads of the winding 30 shown in the slot diagrams of FIG. 1-3 in order to configure the winding in a slightly different manner. In the second embodiment of the winding arrangement disclosed above, the orange half-paths are connected in series with the blue half-paths (e.g., A orange connected to A blue, B orange connected to B blue, etc. However, in one configuration of the winding arrangement, two of the same-color half-paths are connected in series to form one of the parallel paths. For example, A orange is connected to C orange, B orange is connected to D orange, A blue is connected to C blue, and B blue is connected to D blue. This is accomplished with similar power and neutral leads to those shown in FIG. 1 (as noted by the red circles), but the connections between the half-paths are different. Specifically, the following connections are made: (i) half-path A orange at layer #1 of slot #7 is connected to half-path C orange at layer #2 of slot #70; (ii) half-path B orange at layer #1 of slot #8 is connected to half-path D orange at layer #2 of slot #69; (iii) half-path A blue at layer #1 of slot #69 is connected to half-path C1 and C2 blue at layer #s 11 and 12 of slot #55; and (iv) half-path B blue at layer #1 of slot #70 is connected to half-path D1 and D2 at layer #s 11 and 12 of slot #56.

It will be recognized that the winding arrangement 30 involves the use of a weave between slot sets 36₁ and 36₂ that is advantageous in order to move the leads in slot set 36₁ from layer #2 to layer #1 (i.e., the outermost layer). By moving the leads to layer #1, the leads may be easily connected over the back iron of the core.

In yet another example of a possible embodiment of the winding arrangement 30, the orange paths and the blue paths are all connected in parallel (i.e., for a total of eight parallel paths).

It will be recognized that the winding arrangement 30 includes large cross-sectional wires and small cross-sectional wires that extend through each slot 16 of the stator core 12. The number of large cross-sectional wires is typically an even number (e.g., 2, 4, 6, 8 or 10), and the number of small cross-sectional wires is also an even number (e.g., 2, 4 or 6). In the embodiment of FIGS. 1-3, eight large wires are housed in the back of each slot and four small wires are housed in the front of each slot. The large and small wires are connected together as described herein to form multiple parallel paths for each phase of the winding arrangement. In the winding arrangement disclosed herein, each slot shares two parallel paths. For example, slot #7 shares paths A and D, and slot #8 shares slots B and C.

The two smaller wires look the same and are stacked in the radial direction. Therefore the two wires should have at least one weave so the two smaller wires are electrically balanced. Electrically balanced parallel wires reduce recirculating currents and increase motor efficiency. Balanced wires should have the same or similar average layer position in all the slots. The weave swaps the radial layers of the two parallel wires so that they have the same or similar layer average for the whole winding.

To reduce the total amount of weaves, the large wires may be inserted with half the leads on Side A and half the leads on Side B. In at least one embodiment, the orange conductors in FIGS. 1-3 illustrate the conductors that are associated with a first of two parallel paths for the phase and the blue conductors illustrate the conductors that are associated with a second of two parallel paths for the phase. The light orange color represents one axial conductor/winding direction for the path in the associated slot (e.g., from the first end 26 to the second end 28 of the core), and the darker orange color represents the opposite conductor/winding direction for the path in the associated slot (e.g., from the second end 28 to the first end 26 of the core).

The weave shown in between slot #s 10 and 19 of the large wires on the OD of the stator assists, not with balancing, but to put the orange leads A, B, C, D in slots 7, 8, 9, 10 on the outside layer of the winding. These leads should be on the outer layer so that the blue leads in the outside layer C, D, A, B in slots 67-70 can be reverse twisted and easily connected (welded) to the leads A, B, C, D in slots 7-10.

The series connection at side A is shown in FIG. 3 by two small wires welded to one large wire. For example, A1 and A2 located over slot #25 are bent over the end loops (as shown) and welded to A over slot #25. The leads in FIG. 3 are shown after they twist and follow the angle of the common end loops for 6 slots. The large leads A, B, C, D twist to the left and the smaller leads A1, A2, B1, B2, C1, C2, D1, D2 twist to the right.

The foregoing description of one or more embodiments of the continuous stator winding with large and small wires has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by any appended claims. Therefore, the spirit and scope of any appended claims should not be limited to the description of the embodiments contained herein.

What is claimed is:

1. A stator for an electric machine comprising:
a stator core including a plurality of teeth with slots formed between the teeth, the stator core defining an inner diameter (ID) and an outer diameter (OD), each slot of the stator core including a back portion closer to the OD and a front portion closer to the ID; and
a winding arrangement positioned on the stator core, the winding arrangement including a plurality of conductors forming a plurality of parallel paths, each parallel path including a first half-path connected in series with a second half-path,
the first half-path including an outer portion arranged in the back portion of each slot and an inner portion arranged in the front portion of each slot, the outer portion provided by at least one first continuous conductor having a first cross-sectional area and arranged in at least one of two layers in the back portion of each slot, the inner portion provided by at least two second continuous conductors having a second cross-sectional area and arranged in at least one of two layers in the front portion of each slot, the first cross-sectional area at least 50% greater than the second cross-sectional area, wherein the at least two second continuous conductors are connected in parallel, and wherein the at least one first continuous conductor is connected in series with the at least two second continuous conductors; and
the second half-path including an outer portion arranged in the back portion of each slot and an inner portion arranged in the front portion of each slot, the outer portion provided by at least one first continuous conductor having a first cross-sectional area and arranged in at least one of two layers in the back portion of each slot, the inner portion provided by at least two second continuous conductors having a second cross-sectional area and arranged in at least one of two layers in the front portion of each slot, the first cross-sectional area at least 50% greater than the second cross-sectional area, wherein the at least two second continuous conductors are connected in parallel, and wherein the at least one first continuous conductor is connected in series with the at least two second continuous conductors;
wherein the at least two second continuous conductors of the second half path are connected in series with the at least one first continuous conductor of the first half path.

2. The stator of claim 1 wherein the at least one continuous conductor of each first half-path comprises a primary continuous wire and a secondary continuous wire.

3. The stator of claim 2 wherein the at least one continuous conductor of the first half-path includes a primary length of continuous wire and a secondary length of continuous wire, wherein the secondary length of continuous wire is at least twice as long as the primary length of continuous wire, wherein the primary length of continuous wire is retained in two outermost slots and the secondary length of continuous wire is retained in slots radially inward from the two outermost slots.

4. The stator of claim 3 wherein the at least two second continuous conductors are connected to the secondary length of continuous wire by a coupling.

5. The stator of claim 4 wherein the coupling is a first coupling, the stator further comprising a second coupling that connects the at least two second continuous conductors to the primary length of continuous wire.

6. The stator of claim 5 wherein the first coupling is a first weld that connects the secondary length of continuous wire to the at least two second continuous conductors, and the second coupling is a second weld that connects the at least two second continuous conductors to the primary length of continuous wire.

7. The stator of claim 3 wherein the first length of continuous wire and the second length of continuous wire are connected by a weld coupling that connects the first length of continuous wire and the second length of continuous wire.

8. The stator of claim 7 wherein one side of the second length of continuous wire serves as a start lead for one of the plurality of parallel paths, and wherein a finish lead of one of the second half-paths serves as a finish lead for the said one of the plurality of parallel paths.

9. The stator of claim 3 wherein a finish lead for the primary length of continuous wire and a start lead of one of the second half-paths are connected together to serve as an internal series connection for one of the plurality of parallel paths.

10. The stator of claim 3 wherein end turns along the at least one first continuous conductor of the first half-path and second half path are substantially weaveless, and wherein end turns along the at least two second continuous conductors along the first half-path and the second half-path include a plurality of weaves.

11. The stator of claim 1, wherein the start leads and the finish leads for the plurality of parallel paths are all positioned in one of two backmost layers and a frontmost layer on a same half of the stator core.

12. The stator of claim 1 wherein the winding arrangement is defined by four slots per pole per phase.

13. The stator of claim 12 wherein each of the plurality of parallel paths includes a first set of adjacent parallel paths and a second set of adjacent parallel paths, the first set of adjacent parallel paths including a first parallel path and a second parallel path, wherein a position of the first parallel path relative to the second parallel path alternate at successive adjacent poles for an entirety of the first parallel path and the second parallel path, and wherein all end turns positioned along the first path and the second path are configured as over-under end turns.

14. A stator for an electric machine comprising:
a stator core including a plurality of teeth with slots formed between the teeth, the stator core defining an inner diameter (ID) and an outer diameter (OD), each slot of the stator core including a back portion closer to the OD and a front portion closer to the ID; and
a winding arrangement positioned on the stator core, the winding arrangement including a plurality of conductors forming a plurality of parallel paths, each parallel path including a first half-path connected in series with a second half-path,
the first half-path including an outer portion arranged in the back portion of each slot and an inner portion arranged in the front portion of each slot, the outer portion provided by at least one first continuous conductor having a first cross-sectional area, wherein end turns along the at least one first continuous conductor are weaveless, the inner portion provided by at least two second continuous conductors having a second cross-sectional area and arranged in at least one of two layers in the front portion of each slot, the first cross-sectional area greater than the second cross-sectional area, wherein the at least two second continuous conductors are connected in parallel, wherein end turns along the at least two second continuous conductors include weaves, and wherein the at least one first continuous conductor is connected in series with the at least two second continuous conductors; and
the second half-path including an outer portion arranged in the back portion of each slot and an inner portion arranged in the front portion of each slot, the outer portion provided by at least one first continuous conductor having a first cross-sectional area, wherein end turns along the at least one first continuous conductor are weaveless, the inner portion provided by at least two second continuous conductors having a second cross-sectional area and arranged in at least one of two layers in the front portion of each slot, the first cross-sectional area greater than the second cross-sectional area, wherein the at least two second continuous conductors are connected in parallel, wherein end turns along the at least two second continuous conductors include weaves, and wherein the at least one first continuous conductor is connected in series with the at least two second continuous conductors.

15. The stator of claim 14 wherein the at least two second continuous conductors of the first half path are connected in series with the at least one first continuous conductor of the second half path.

16. The stator of claim 15 wherein the at least one continuous conductor of each first half-path and second half path comprises a primary continuous wire and a secondary continuous wire.

17. The stator of claim 16 wherein a finish lead of the secondary continuous wire is connected to start leads of the at least two second continuous conductors, and wherein finish leads of the at least two second continuous conductors are connected to a start lead of the primary continuous wire.

18. A stator for an electric machine comprising:
a stator core including a plurality of teeth with slots formed between the teeth, the stator core defining an inner diameter (ID) and an outer diameter (OD), each slot of the stator core including a back portion closer to the OD and a front portion closer to the ID; and
a winding arrangement positioned on the stator core, the winding arrangement including a plurality of conductors forming a plurality of parallel paths, each parallel path including an outer portion arranged in the back portion of each slot and an inner portion arranged in the front portion of each slot,
the outer portion provided by primary continuous conductor and a secondary continuous conductor, the primary continuous conductor and the secondary continuous conductor having a first cross-sectional area and arranged in at least two layers in the back portion of each slot,
the inner portion provided by at least two second continuous conductors having a second cross-sectional area and arranged in at least one of two layers in the front portion of each slot, the first cross-sectional area greater than the second cross-sectional area, wherein the at least two second continuous conductors are connected in parallel, and wherein a finish lead of the secondary continuous conductor is connected in series with start leads of the at least two second continuous conductors, and wherein a start lead of the primary continuous conductor is connected in series with finish leads of the at least two second continuous conductors.

19. The stator of claim 18 wherein the outer portion and the inner portion are configured as a first half-path of the one of the plurality of parallel paths, said one of the plurality of parallel paths further comprising a second half-path connected in series with the first half path.

20. The stator of claim 18 wherein start leads and finish leads for all of the plurality of parallel paths are positioned on one side of the stator.
